(19) United States
(12) Patent Application Publication
(10) Pub. No.: US 2008/0110136 A1
(43) Pub. Date: May 15, 2008

(54) System and method for unpacking vacuum packages

(76) Inventors: Shaoyong Liu, Singapore (SG); Jing Fang Pan, Singapore (SG); Yi Zhao Yao, Singapore (SG); Kor Seng Ang, Singapore (SG); Sivalingam Marimuthu, Singapore (SG)

Correspondence Address: HITACHI C/O WAGNER BLECHER LLP, 123 WESTRIDGE DRIVE, WATSONVILLE, CA, 95076, US

(21) Appl. No.: 11/598,978

(22) Filed: Nov. 13, 2006

(51) Int. Cl. B67B 7/00; B65B 31/04; B65B 55/00; B65B 43/26

(52) U.S. Cl. 53/492; 53/432; 53/510; 53/381.1

(57) ABSTRACT

A system and method for opening a vacuum package is disclosed. The method includes providing a chamber at a normal pressure and loading the chamber with a vacuum package wherein the vacuum package is at a first pressure. The method also includes applying a vacuum to the chamber such that the pressure inside the chamber is substantially equal to the first pressure. The method further includes opening the vacuum package and equalizing the pressure inside the chamber to the normal pressure.

### TECHNICAL FIELD

This invention relates generally to the field of packaging. More particularly, the invention relates to a system and method for unpacking vacuum packages.

### BACKGROUND ART

For incoming hard disk drive (HDD) components, vacuum packaging at the supplier site provides some advantages over normal packaging. For example, a vacuum packaged part exhibits less particle generation due to part on part contact than it would if packaged in a conventional package. Further advantages of a vacuum package over a conventional package include less corrosion and oxidation of parts and less airborne particle contamination of parts.

At the disk drive manufacturing site, the opening of incoming vacuum packages requires great care, especially for non-washable key components such as an actuator pivot, spindle motor, disk, and head gimbal assembly (HGA). For a pivot or motor (ball bearing), sudden opening of the vacuum package can result in unbalanced pressure, causing potential oil leakage problems.

Sudden opening of a vacuum package can also cause particles (outside of the package) to be sucked into the package, causing particulate contamination. In addition, the cutting tool used to open the package can cause particulate contamination which can be sucked into the vacuum package. In addition, the cutting tool used to open the package can generate static electricity, potentially damaging sensitive parts. Particles sucked into the vacuum package can also induce static or electrical contamination of the parts.

### SUMMARY OF THE INVENTION

A system and method for opening a vacuum package is disclosed. The method includes providing a chamber at a normal pressure and loading the chamber with a vacuum package wherein the vacuum package is at a first pressure. The method also includes applying a vacuum to the chamber such that the pressure inside the chamber is substantially equal to the first pressure. The method further includes opening the vacuum package and equalizing the pressure inside the chamber to the normal pressure.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram of an exemplary system for opening a vacuum package in accordance with one embodiment of the present invention.

FIG. 2 is a flow diagram of an exemplary method for opening a vacuum package in accordance with one embodiment of the present invention.

FIG. 3 is a flow diagram of an exemplary method for opening a vacuum package and removing contents of the vacuum package in accordance with one embodiment of the present invention.

### DETAILED DESCRIPTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Embodiments of the present invention include a system and method for opening a vacuum package. The present system and method for opening a vacuum package overcomes problems associated with opening a vacuum package such as particle contamination, static charge contamination, oil leakage problems, etc. because embodiments of the present invention provide a controlled environment for opening the vacuum packages.

The present invention provides a pressure chamber for opening a vacuum package. In one embodiment of the invention, the pressure inside a vacuum package is known (e.g., provided by the supplier). The vacuum package is placed inside the vacuum chamber and the chamber is pressurized to approximately the pressure inside the vacuum package. Once the pressure inside the chamber is close to the pressure inside the vacuum package, the package is opened and the contents are removed. Subsequently, the chamber is re-pressurized to ambient pressure and the parts are removed.

By opening the vacuum package in a chamber at the same pressure as the vacuum package, opening the package does not induce rapid pressure change which could result in contaminates entering the package. Furthermore, in one embodiment of the invention, the pressure is gradually brought back to ambient pressure, reducing oil leakage problems that can be caused by the rapid pressure change experienced by opening the vacuum package under ambient pressure.

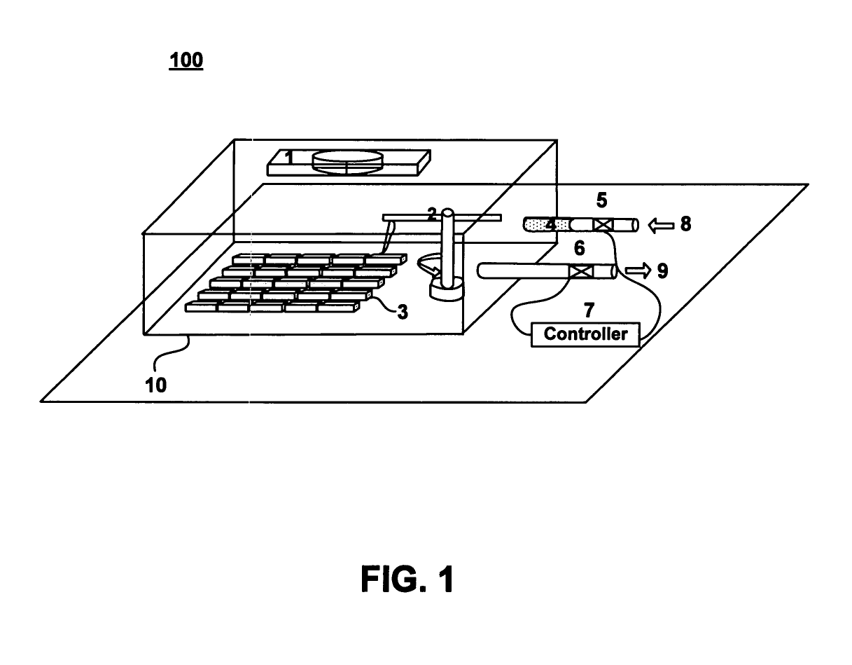

FIG. 1 is a diagram of an exemplary system 100 for opening a vacuum package 3 in accordance with embodiments of the present invention. System 100 includes a pressure chamber 10. Pressure chamber 10 can be any shape or size and can be made from almost any material. However, it is appreciated that a transparent material provides an operator an improved view inside the chamber compared to a material that is not transparent.

Coupled to the pressure chamber 10 is a cutting device 2 which is operable to open the vacuum package 3. In one embodiment of the invention, cutting tool 3 is a single blade to reduce particle contamination inside the chamber. For example, scissors use two blades to provide a cutting action. It is possible that the contact between the two blades can generate particulate contamination and therefore, a single blade cutting tool 3 is used. However, it is appreciated that a multi-blade cutting tool could be used if particulate contamination is considered. In one embodiment of the invention, the cutting tool 2 is automated and can be controlled by controller 7.

The pressure chamber 10 comprises an inlet 8 and an outlet 9 for adjusting the pressure inside the chamber 10. In one embodiment of the invention, the inlet 8 includes an inline filter 4 for filtering air (or any other media) prior to entering the chamber. In one embodiment of the invention, compressed dry air (CDA) is provided by inlet 8 to increase the pressure in the pressure chamber 10, however, it is appreciated that any air or media could be used in accordance with embodiments of the present invention.

In one embodiment of the invention, the inlet includes a valve 5 for controlling the flow into the chamber 10. The outlet 9 also includes a valve 6 for controlling the flow out of the chamber 10. In one embodiment of the invention, valves 5 and 6 are computer controlled by controller 7. It is appreciated that outlet 9 may be coupled to a vacuum source (not shown) for reducing the pressure inside the pressure chamber 10. In one embodiment of the invention, the inlet 8 and outlet 9 are combined into a single airway.

System 100 further includes an ionizer 1 for reducing static or magnetic charges inside the chamber 10. In one embodiment of the invention, the ionizer 1 is controlled by controller 7.

In one embodiment of the invention, system 100 is housed in a clean room environment. This helps reduce contamination after the parts are removed from the pressure chamber 10. In this embodiment of the invention, ambient air can be provided through inlet 8 to increase pressure in the chamber 10. It is appreciated that the air may be conditioned before entering the chamber (e.g., filtered, moisture reduced, heated, cooled, compressed, etc.)

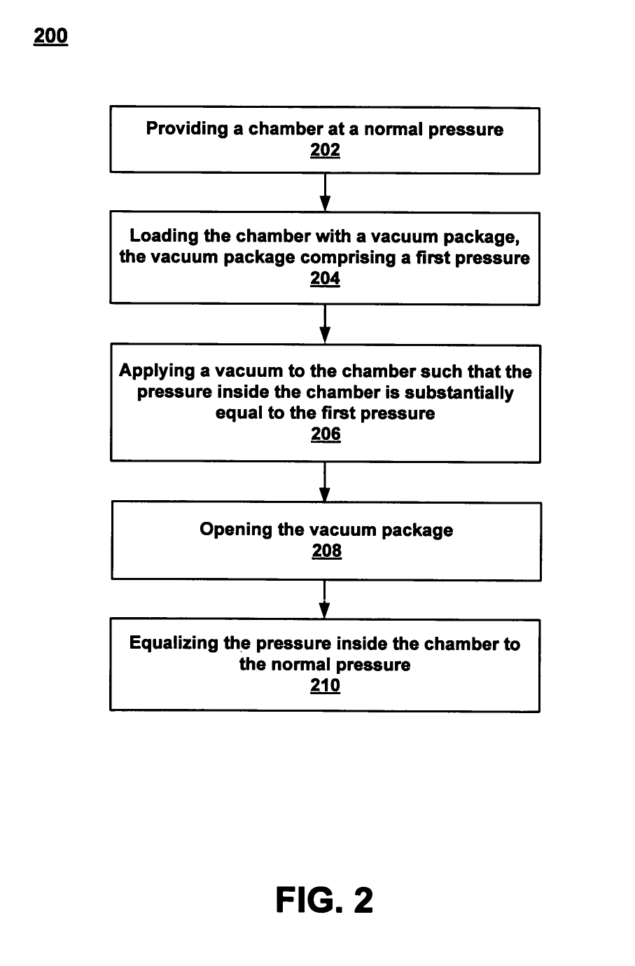

FIG. 2 is a flow diagram of an exemplary method 200 for opening a vacuum package in accordance with one embodiment of the present invention. In one embodiment of the invention, method 200 is performed inside a clean room environment for further contaminate reduction.

At step 202, method 200 includes providing a chamber at a normal pressure. In one embodiment of the invention, the normal pressure is the ambient pressure inside a clean room. The normal pressure may also be any other pressure in accordance with embodiments of the present invention.

At step 204, method 200 includes loading the chamber with a vacuum package, the vacuum package comprising a first pressure. In one embodiment of the invention, the first pressure inside the vacuum package is known, e.g., provided by the supplier. In most cases, the first pressure is lower than the normal pressure.

At step 206, method 200 includes applying a vacuum to the chamber such that the pressure inside the chamber is substantially equal to the first pressure. In one embodiment of the invention, the pressure is gradually reduced from the normal pressure to the first pressure over a period of time. In another embodiment of the invention, the pressure is stepped down from the normal pressure to the first pressure in a series of pressure reductions over a period of time. In one embodiment of the invention, factors such as the package contents, the pressure differential between the normal pressure and the first pressure, and the package specifications are considered when choosing a pressure equalization approach.

At step 208, method 200 includes opening the vacuum package. In one embodiment of the invention, a cutting tool is used to open the package, however, it is appreciated that any device capable of opening the vacuum package in accordance with embodiments of the present invention. The cutting tool can be either manually operated or automated in accordance with the present invention. It is important to consider particulate contamination when selecting a cutting tool. For example, a single blade cutting tool is less likely to produce particulate contamination than a dual blade cutting tool such as scissors wherein two blades contact each other and can create particles.

It is also important to consider static generation when selecting a cutting tool. For example, some materials may generate more static than others. In one embodiment of the invention, an ionizer is used to reduce static and magnetic contamination prior to opening the vacuum package.

At step 210, method 200 includes equalizing the pressure inside the chamber to the normal pressure. In one embodiment of the invention, a computer controlled valve adjusts airflow back into the chamber to equalize the pressure. In one embodiment of the invention, the pressure is gradually increased from the vacuum package pressure back to the normal pressure. In another embodiment of the invention, the pressure is stepped from the vacuum package pressure back to the normal pressure in a series of pressure increases over time. As stated above, factors such as the package contents, the pressure differential between the normal pressure and the vacuum package pressure, and the package specifications are considered when choosing a pressure equalization approach.

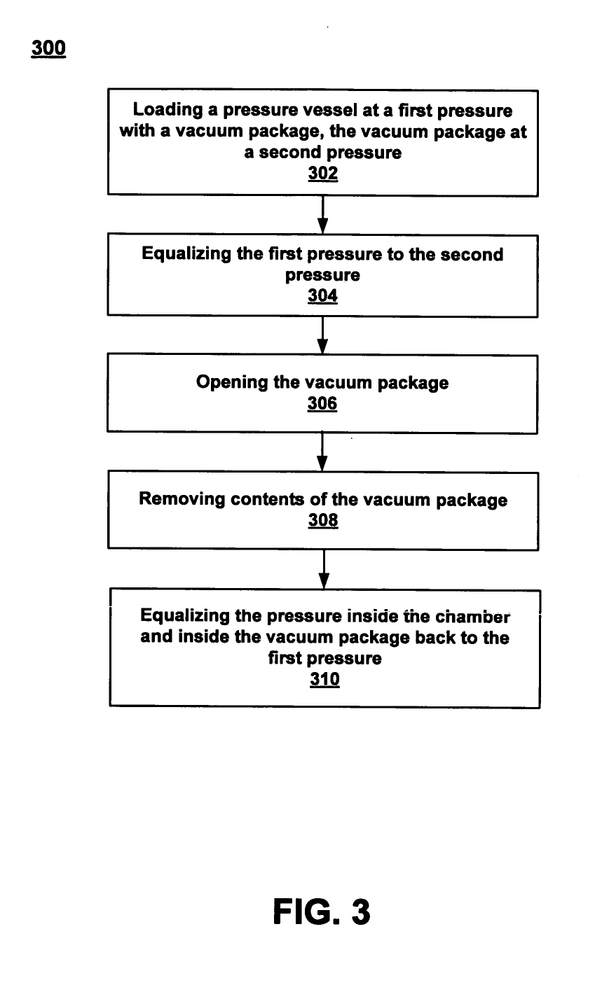

FIG. 3 is a flow diagram of an exemplary method 300 for opening a vacuum package and removing contents of the vacuum package in accordance with one embodiment of the present invention. At step 302, method 300 includes loading a pressure vessel at a first pressure with a vacuum package, the vacuum package at a second pressure. In one embodiment of the invention, the first pressure is ambient pressure and the second pressure is lower than the first pressure.

At step 304, method 300 includes equalizing the first pressure to the second pressure. In one embodiment of the invention, a vacuum source is coupled to the vessel and reduces the pressure in the vessel from the first pressure to approximately the same pressure inside the vacuum package.

At step 306, method 300 includes opening the package. In one embodiment of the invention, prior to opening the package, static charges and/or magnetism is removed from the inside the vessel. In one embodiment of the invention, an ionizer removes electrostatic charges and magnetism from inside the vessel. At step 308, method 300 includes removing the contents from the package.

At step 310, method 300 includes equalizing the pressure inside the chamber back to the first pressure (e.g., ambient pressure). In one embodiment of the invention, an air inlet is coupled to the vessel and air is introduced into the vessel until the first pressure is restored. In one embodiment of the invention, compressed dry air is used to re-pressurize the vessel.

It is appreciated that method 300 may be performed inside a clean room environment. In this embodiment of the invention, the air inside the clean room may be used to equalize the pressure inside the vessel in step 310. It is appreciated that the ambient air (e.g., from the clean room) may be conditioned (e.g., filtered, compressed, dried, etc) prior to being introduced into the vessel.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A method for opening a vacuum package comprising:
providing a chamber at a normal pressure;
loading said chamber with a vacuum package, said vacuum package comprising a first pressure;
applying a vacuum to said chamber such that the pressure inside said chamber is substantially equal to said first pressure;
opening said vacuum package; and
equalizing the pressure inside said chamber to said normal pressure.

2. The method as described in claim 1 further comprising:
neutralizing static charges inside said chamber prior to opening said vacuum package.

3. The method as described in claim 1 wherein said equalizing the pressure inside said chamber comprises filling said chamber with compressed dry air.

4. The method as described in claim 1 wherein said equalizing the pressure inside said chamber comprises filling said chamber with a filtered gas.

5. The method as described in claim 1 further comprising:
providing said chamber inside of a clean room environment.

6. The method as described in claim 1 further comprising:
unloading hard disk drive components from said vacuum package.

7. The method as described in claim 1 further comprising:
using a computer controlled valve for said equalizing said pressure inside said chamber to said normal pressure.

8. A method for opening a vacuum package comprising:
loading a pressure vessel at a first pressure with a vacuum package, said vacuum package at a second pressure;
equalizing said first pressure to said second pressure;
opening said vacuum package;
removing contents of said vacuum package; and
equalizing the pressure inside said chamber and inside said vacuum package back to said first pressure.

9. The method as described in claim 8 further comprising:
neutralizing static charges inside said chamber prior to opening said vacuum package.

10. The method as described in claim 9 further comprising utilizing an air ionizer for neutralizing said static charges.

11. The method as described in claim 8 wherein said equalizing said pressure inside said chamber comprises filling said chamber with filtered air.

12. The method as described in claim 8 further comprising:
providing said chamber inside of a clean room environment.

13. The method as described in claim 12 wherein said equalizing said pressure inside said chamber comprises filling said chamber with filtered ambient air inside said clean room.

14. The method as described in claim 8 wherein said equalizing said pressure inside said chamber to said normal pressure is computer controlled.

15. A system for opening a vacuum package comprising:
a chamber comprising a first pressure, said chamber for receiving a vacuum package at a second pressure, said second pressure less than said first pressure;
a vacuum coupled to said chamber for equalizing said first pressure inside said chamber to said second pressure;
a package opener for opening said vacuum package; and
an air supply for increasing the pressure inside said chamber back to said first pressure.

16. The system as described in claim 15 further comprising:
a computer controlled pressure controller for equalizing said first pressure inside said chamber to said second pressure and for increasing the pressure inside said chamber back to said first pressure.

17. The system as described in claim 16 further comprising:
a filter coupled to said air supply for filtering said air prior to flowing into said chamber.

18. The system as described in claim 15 further comprising:
an ionizer for reducing static, charges inside said chamber.

19. The system as described in claim 15 wherein said package opener comprises a cutting tool.

20. The system as described in claim 15 wherein said chamber is provided inside a clean room environment.
